(19) United States
(12) Patent Application Publication
(10) Pub. No.: US 2009/0066797 A1
(43) Pub. Date: Mar. 12, 2009

(54) FLEXIBLE IMAGING DEVICE WITH A PLURALITY OF IMAGING ELEMENTS MOUNTED THEREON

(76) Inventors: Yukiya MIYACHI, Kanagawa (JP); Jin Murayama, Tokyo (JP); Yuichi Ohashi, Tokyo (JP); Shusuke Mogi, Tokyo (JP)

Correspondence Address: BIRCH STEWART KOLASCH & BIRCH, PO BOX 747, FALLS CHURCH, VA, 22040-0747, US

(21) Appl. No.: 12/198,698

(22) Filed: Aug. 26, 2008

(30) Foreign Application Priority Data
Aug. 29, 2007 (JP) P2007-222780

(51) Int. Cl. H04N 5/225

(52) U.S. Cl. 348/207.99

(57) ABSTRACT

A flexible imaging device comprises: a flexible substrate; and a plurality of imaging elements mounted on the flexible substrate.

### BACKGROUND OF THE INVENTION

1. Field of the Invention

The present invention relates to an imaging device with a plurality of imaging elements mounted thereon, and more particularly to a flexible imaging device in which shooting directions of a plurality of imaging elements can be set to arbitrary directions.

2. Description of the Related Art

Vehicle-mounted cameras for shooting images of such as a front side, a lateral side, a back side, or an interior a motor vehicle such as an automobile, and monitoring cameras for ensuring security are becoming widespread. As solid-state imaging elements which are mounted on these cameras, those which afford a high aspect ratio and a wide view angle are suitable. However, such solid-state imaging elements have a problem in that their production yield is low, resulting in a high production cost. Further, there is an additional problem in that when a moving image of an object is shot, it is impossible to increase the frame rate.

Accordingly, conventionally, as disclosed in, for example, JP-A-62-10988 and JP-A-62-11264, a plurality of solid-state imaging elements are accommodated in one package, and images shot by the respective solid-state imaging elements are synthesized to thereby shoot images with a high aspect ratio and a wide view angle and increase the frame rate of the moving images.

By mounting a plurality of solid-state imaging elements and by synthesizing images shot by the individual solid-state imaging elements, it is possible to obtain images of a wide view angle and improve the frame rate of the moving picture.

However, in a case where it is desired to install a monitoring camera at, for instance, a corner of a house and obtain both a monitoring image in a frontal direction of the house and a monitoring image in a lateral direction of the house, i.e., a 90-degree direction to the front side, two monitoring cameras would be required. Hence, there is a problem in that the number of monitoring cameras required increases, resulting in a higher cost.

### SUMMARY OF THE INVENTION

An object of the invention is to provide a flexible imaging device with a plurality of imaging elements mounted thereon which is capable of shooting video pictures in an arbitrary number of directions with one imaging device.

According to the invention, there is provided a flexible imaging device comprising: a flexible substrate; and a plurality of imaging elements mounted on the flexible substrate.

According to the invention, there is provided the flexible imaging device, wherein said plurality of imaging elements are at least three imaging elements, and at least two of said at least three imaging elements are accommodated in one common package.

According to the invention, there is provided the flexible imaging device, wherein the at least two imaging elements accommodated in the one common package are imaging elements which are formed adjacently on an identical semiconductor wafer and are diced out as an integral piece.

According to the invention, there is provided the flexible imaging device, wherein the package is a laminated ceramic package.

According to the invention, there is provided the flexible imaging device, further comprising: a lens array fitted to the package; and imaging lenses respectively provided for said plurality of imaging elements inside the package.

According to the invention, there is provided the flexible imaging device, further comprising: a timing generator that imparts an identical drive signal to each of said plurality of imaging elements.

According to the invention, there is provided the flexible imaging device, further comprising a first substrate on which (i) the timing generator, (ii) preprocessing sections, provided in correspondence with the imaging elements respectively, each of which preprocesses an output signal from corresponding one of the imaging elements, (iii) digital signal processing sections, provided in correspondence with the imaging elements, each of which image processes an output signal from corresponding one of the preprocessing sections, and (iv) arithmetic processing sections that integratedly processes output image data from the digital signal processing sections are mounted, wherein the first substrate is provided continuously to the flexible substrate.

According to the invention, there is provided the flexible imaging device, which has a connection configuration such that said plurality of imaging elements and the timing generator are connected by a common wiring, wherein an identical drive signal is branched from the common wiring to each of the imaging elements.

According to the invention, there is provided the flexible imaging device, wherein said plurality of imaging elements comprise filters having different transmission characteristics, the filters being provided in front of light receiving surfaces of the imaging elements respectively.

According to the invention, there is provided the flexible imaging device, wherein the imaging elements are of a CCD type.

According to the invention, there is provided the flexible imaging device, wherein the arithmetic processing section comprises a section that, when two of the imaging elements are shooting an identical object, calculates a distance to the object from a distance between the two imaging elements and images shot by the imaging elements.

According to the invention, there is provided the flexible imaging device, wherein the arithmetic processing section comprises a section that outputs an alarm upon detecting that the calculated distance to the object has reached a threshold distance or less.

According to the invention, there is provided the flexible imaging device which is a vehicle-mounted camera.

According to the invention, there is provided the flexible imaging device which is a monitoring camera.

### BRIEF DESCRIPTION OF THE DRAWINGS

FIG. 1 is a functional block diagram of an imaging device in accordance with an embodiment of the invention;

FIG. 2 is a schematic side view of the imaging device in accordance with the embodiment shown in FIG. 1;

FIG. 3 is an enlarged view of an imaging element package portion of the imaging device shown in FIG. 2;

FIG. 4 is an enlarged view of a connecting portion between electronic circuitry and the imaging element package portion shown in FIG. 2;

FIG. 5 is a schematic top view of the imaging device shown in FIG. 2;

FIG. 6 is a diagram illustrating a molded lens portion which is mounted on the imaging element package portion shown in FIG. 2;

FIG. 7 is a diagram illustrating a lens array unit which is used instead of the lens portion shown in FIG. 6 and in which each lens has a three-piece lens configuration;

FIGS. 8A to 8C are diagrams explaining a preferable form of two solid-state imaging elements which are accommodated in the imaging element package shown in FIG. 2;

FIG. 9 is a diagram illustrating an example in which the flexible imaging devices in accordance with the invention are used as vehicle-mounted cameras;

FIGS. 10A and 10B are diagram illustrating an example in which the flexible imaging devices in accordance with the invention are used as monitoring cameras; and

FIGS. 11A and 11B are explanatory diagrams of an imaging device in which imaging elements are chip-size packaged.

### DETAILED DESCRIPTION OF THE INVENTION

Referring now to the accompanying drawings, a description will be given of an embodiment of the invention.

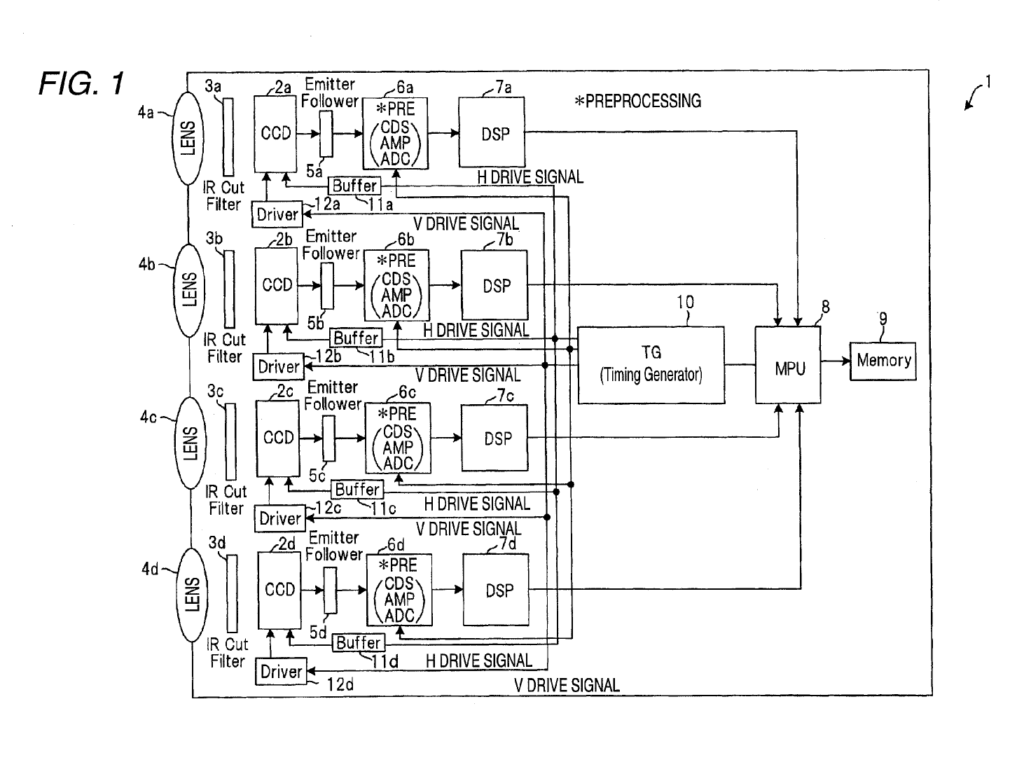

FIG. 1 is a functional block diagram of a flexible imaging device in accordance with an embodiment of the invention. An imaging device 1 in accordance with this embodiment has a plurality of (in the illustrated example, four) solid-state imaging elements 2a, 2b, 2c, and 2d mounted thereon. The illustrated solid-state imaging elements 2a, 2b, 2c, and 2d are CCD type solid-state imaging elements, and the respective CCD type solid-state imaging elements 2a, 2b, 2c, and 2d are configured to have the same number of pixels, vertical charge transfer paths (VCCD) having the same number of stages, and horizontal charge transfer paths (HCCD) having the same number of stages, and to be driven by the same drive voltage.

Infrared cut filters 3a, 3b, 3c, and 3d are respectively provided in front of the solid-state imaging elements 2a, 2b, 2c, and 2d, and imaging lenses 4a, 4b, 4c, and 4d are further provided in preceding stages thereof.

Emitter followers 5a, 5b, 5c, and 5d are provided at output stages of the respective solid-state imaging elements 2a, 2b, 2c, and 2d. Provided at rear stages of the respective emitter followers 5a, 5b, 5c, and 5d are known preprocessing units (correlational double sampling (CDS) processing units, gain control unit analog-to-digital conversion (ADC) portions, etc.) 6a, 6b, 6c, and 6d which are known in the CCD type solid-state imaging elements. It should be noted that there are cases where the emitter followers 5a, 5b, 5c, and 5d are omitted depending on the initial stage characteristics of the preprocessing units.

Outputs of the preprocessing units 6a, 6b, 6c, and 6d are connected to digital signal processing (DSP) units 7a, 7b, 7c, and 7d, outputs from the respective are connected to a microprocessor unit (MPU) 8 for integratedly controlling the imaging device 1, and an output from the microprocessor 8 is connected to a memory 9 for image recording. It should be noted that a configuration may be provided such that four microprocessors 8 and four memories 9 are provided in correspondence with the CCD type solid-state imaging elements 2a, 2b, 2c, and 2d.

The driving of the respective CCD type solid-state imaging elements 2a, 2b, 2c, and 2d is controlled by V drive signals (a read pulse signal, a vertical transfer pulse, and an electronic shutter pulse) for driving the vertical charge transfer paths (VCCD) and H drive signals (a horizontal transfer pulse and a reset pulse) for driving the horizontal charge transfer paths (HCCD).

In addition, the preprocessing units 6a, 6b, 6c, and 6d are controlled by drive signals including, for example, a sampling pulse signal for determining the feedthrough level in the correlational double sampling processing, a sampling pulse signal for determining the data level, and a sampling pulse of the analog-to-digital conversion portions.

In this embodiment, these drive signals are configured to be generated by one timing generator (TG) 10 provided in common to the four solid-state imaging elements 2a, 2b, 2c, and 2d and the four preprocessing units 6a, 6b, 6c, and 6d.

Namely, in response to an instruction from the microprocessor 8, the timing generator 10 generates and outputs drive signals for the preprocessing units, H drive signals, and V drive signals. The drive signals for the preprocessing units are branched into four signals, which are respectively supplied to the preprocessing units 6a, 6b, 6c, and 6d.

In addition, the H drive signals generated by the timing generator 10 are branched into four signals, which are respectively supplied to the horizontal charge transfer paths (HCCD) and the like of the respective CCD type solid-state imaging elements 2a, 2b, 2c, and 2d through buffers 11a, 11b, 11c, and 11d. It should be noted that the buffers 11a to 11d are not essentially required circuit elements, and may not be used.

Further, the V drive signals generated by the timing generator 10 are branched into four signals, which are respectively supplied to the vertical charge transfer paths (VCCD) and the like of the respective CCD type solid-state imaging elements 2a, 2b, 2c, and 2d through drivers 12a, 12b, 12c, and 12d.

As a result, the four CCD type solid-state imaging elements 2a, 2b, 2c, and 2d perform respective operations (exposure, readout, transfer, and output) completely identically and simultaneously, and the four preprocessing units 6a, 6b, 6c, and 6d also perform sampling processing and the like in a completely identical operational state. Accordingly, differences among the picked-up image signals which are outputted from the four CCD type solid-state imaging elements 2a, 2b, 2c, and 2d are those which are ascribable only to differences among the positions of layout of the four CCD type solid-state imaging elements 2a, 2b, 2c, and 2d.

A device with a plurality of imaging elements mounted in one camera conventionally exists. For example, a three-plate type camera is so configured that three imaging elements for imaging a red-color image, imaging a green-color image, and imaging a blue-color image are accommodated in one camera, and incident light is divided into three components, which are made incident upon the respective imaging elements. With the conventional three-plate type camera, timing generators are separately provided in correspondence with the respective imaging elements, and the three timing generators are adapted to generate horizontal transfer pulses and vertical transfer pulses separately on the basis of common horizontal synchronizing signals HD and vertical synchronizing signals to drive the respective imaging elements.

In contrast, in the imaging device in accordance with this embodiment, since the plurality of imaging elements are driven by the output signal of one timing generator, the plurality of imaging elements perform not mere synchronous operation but completely identical and simultaneous operation.

Namely, timings at which detection signals of pixels (light receiving elements) located at the same coordinate positions on the respective light receiving surfaces are outputted from the respective imaging elements are identical, timings at which preprocessing is carried out are also identical, timings at which image processing is carried out are identical, and timings at which data are stored in the memory 9 are also identical. In a case where four memories 9 are provided, timings of storage of data which are stored at the same address in the memories are also identical.

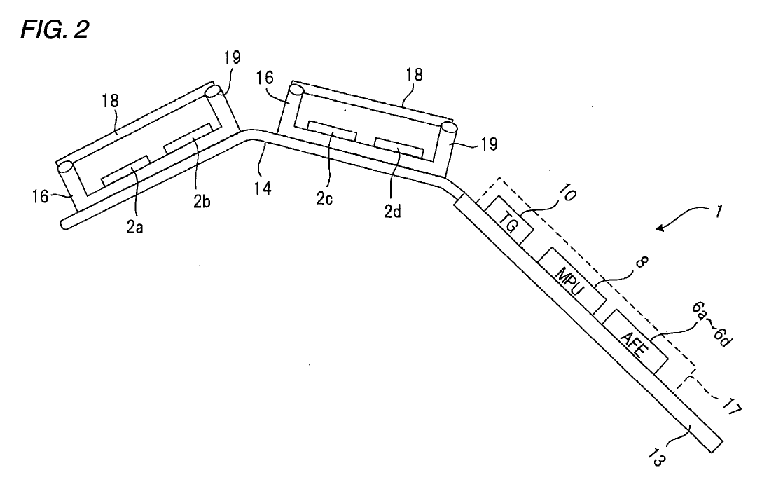

FIG. 2 is across-sectional schematic diagram of the flexible imaging device shown in FIG. 1. Substrates for mounting the imaging device 1, which are used in this embodiment, are of two kinds, and are constituted by a first substrate 13 and a second substrate 14. The first substrate 13 is constituted by a hard substrate such as a printed circuit board, and electronic circuitry 17 is mounted thereon. The electric circuitry 17 includes such as the timing generator 10, the preprocessors 6a to 6d, the DSPs 7a to 7d, and the MPU 8 described with reference to FIG. 1. The memory 9 shown in FIG. 1 is constituted by, for example, a detachable flash memory, a hard disk, or the like, and is therefore installed in a separate place.

The second substrate 14 is constituted by a flexible substrate, and the four solid-state imaging elements 2a to 2d are mounted on this flexible substrate 14. In the illustrated example, the solid-state imaging elements 2a and 2b are accommodated in a common package 16, and the solid-state imaging elements 2c and 2d are accommodated in another common package 16. These packages 16 are fixed on the flexible substrate 14.

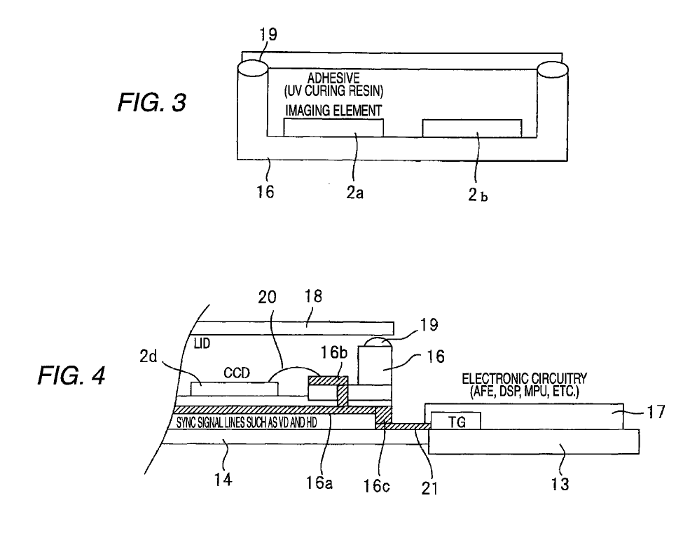

As shown in FIG. 3, the respective packages 16 are formed by, for example, a laminated ceramic. To enhance the positioning accuracy of the two solid-state imaging elements to be accommodated, engraved marks positioned with high accuracy are provided on its inner bottom surface, and the solid-state imaging elements are mounted in accordance with these engraved marks.

After accommodating the solid-state imaging elements in the package 16, a package opening serving as a plane of incidence of the light is closed by a transparent glass lid 18. The glass lid 18 is adhered to the package opening portion by an adhesive 19 such as an ultraviolet (UV) curing resin or the like.

FIG. 4 is a wiring connection diagram between the electronic circuitry 17 and the laminated ceramic-made package 16. A wiring layer 16a is laminated in the interior of the laminated ceramic-made package 16, and this wiring layer 16a is connected to connection pads 16b inside the package 16. Then, the connection pads 16b are connected to the solid-state imaging element 2d by a bonding wire 20. This wiring layer 16a is extended to an outer surface of a side portion of the package 16, and this extended portion 16c is connected to the timing generator 10 and the like of the electronic circuitry 17 by a wiring 21.

The wiring 21 is laid on the flexible substrate 14 further to a further distance, the package 16 accommodating the solid-state imaging elements 2a and 2b accommodated therein is connected to this wiring 21 in the same way as in FIG. 4. Alternatively, an arrangement may be provided such that the wiring layers 16a of the two packages 16 are connected by the wiring laid on the flexible substrate 14 to provide a common wiring.

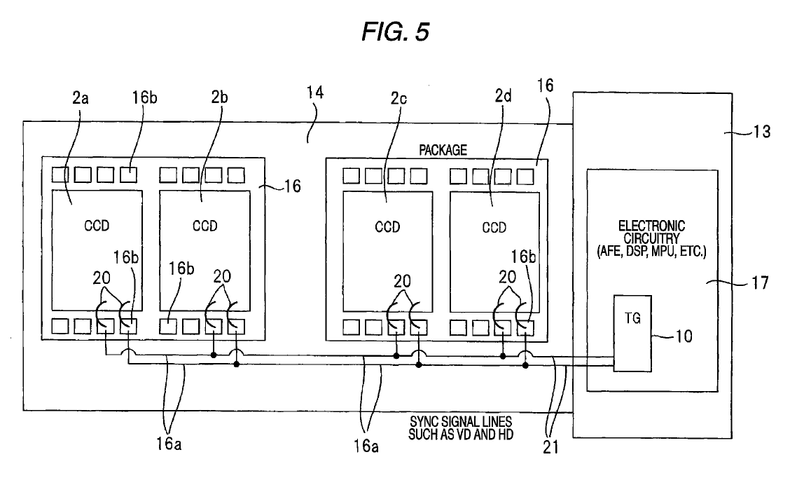

FIG. 5 is a top view of FIG. 2. The flexible substrate 14 is provided continuously to the first substrate 13, and the two imaging element packages 16 respectively accommodating two solid-state imaging elements therein are mounted on the flexible substrate 14. Drive signals from the timing generator 10 are distributed to the respective solid-state imaging elements 2a, 2b, 2c, and 2d through the common wiring 21, and the solid-state imaging elements 2a, 2b, 2c, and 2d operate at the same timing.

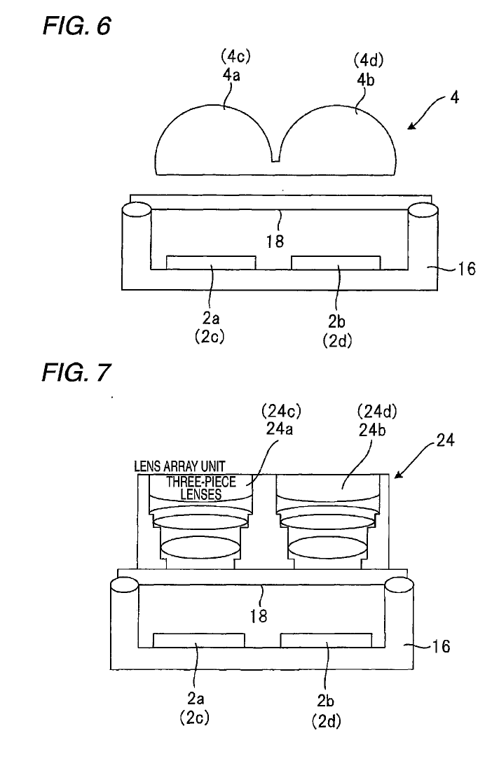

FIG. 6 is a diagram illustrating a lens portion which is mounted on the glass lid 18 adhered to the opening portion of the package 16. This lens portion 4 has a lens array configuration in which two focusing lenses (imaging lenses in FIG. 1) 4a and 4b (or 4c or 4d) are juxtaposedly provided in correspondence with the two solid-state imaging elements 2a and 2b (or 2c and 2d) juxtaposed in the package 16, and are plastic-molded integrally. Field light focused by the respective focusing lenses 4a to 4d forms images on light receiving surfaces of the respective solid-state imaging elements 2a to 2d.

FIG. 7 is a schematic diagram of the lens portion in accordance with a different embodiment from that shown in FIG. 6. In FIG. 6, the lenses are respectively constituted by the focusing lenses 4a to 4d of the one-piece configuration. In the embodiment shown in FIG. 7, however, the lenses are constituted by focusing lens systems respectively formed by three-piece lenses, and a lens portion 24 is formed as a lens array unit in which two focusing lens systems 24a and 24b (or 24c and 24d) are integrally combined.

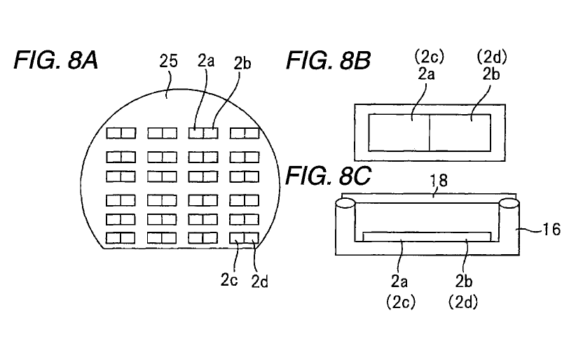

The solid-state imaging elements 2a and 2b (or 2c and 2d) which make up a pair are sufficient if they have the same dimensions and the same number of pixels, and it is preferable to use solid-state imaging elements which are formed in the same manufacturing process. In a most preferable form, as shown in FIG. 8A, of a multiplicity of solid-state imaging elements formed on one semiconductor wafer 25, two adjacent solid-state imaging elements 2a and 2b (or 2c and 2d) are diced as an integral unit without being diced into individual separate pieces, as shown in FIG. 8B.

This diced unit is accommodated in the package 16, as shown in FIG. 8C. In this case, it is preferable to adopt a configuration which facilitates bonding connection by not providing the connection pads 16b between the solid-state imaging elements, as shown in FIG. 5.

In the imaging device 1 in accordance with this embodiment, the MPU 8 integratedly processes images picked up by the four solid-state imaging elements 2a, 2b, 2c, and 2d. At the time of this integrated processing, it is necessary to ascertain the mutual positional relationships among the four solid-state imaging elements 2a to 2d and the respective shooting directions (directions in which the light receiving surfaces are oriented) with high accuracy. In particular, it is necessary to control with high accuracy the mounting positions in the package 16 of the two solid-state imaging elements 2a and 2b (or 2c and 2d) making up a pair. In this sense as well, the embodiment described with reference to FIGS. 8A to 8C is most preferable. The positional accuracy between the mutual ones of the two solid-state imaging elements in the example shown in FIGS. 8A to 8C is the fabrication accuracy of a stepper which is an apparatus for manufacturing the solid-state imaging elements and is on the order of several tens of to several hundreds of nanometers.

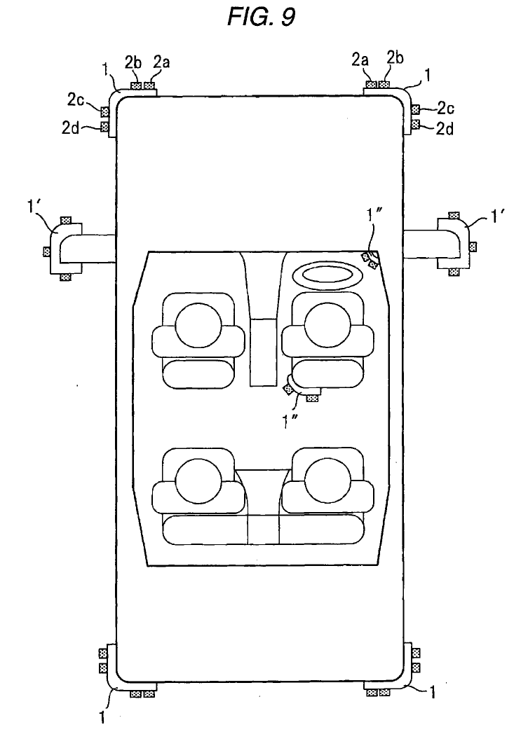

A description will be given of the operation when an object image is shot by the flexible imaging device 1 having the above-described configuration. For example, the imaging devices 1 are installed at positions of various parts of an automobile as vehicle-mounted cameras, as shown in FIG. 9. In the illustrated example, the imaging devices 1 described with reference to FIG. 2 are respectively installed at a right corner portion and a left corner portion of a front portion of the vehicle and a right corner portion and a left corner portion of a rear portion of the vehicle by bending the flexible substrates 14. Further, in the illustrated example, flexible imaging devices 1′ each having three solid-state imaging elements provided thereon are respectively installed at curved surface portions of left and right door mirrors by bending the flexible substrates 14. A flexible imaging device 1″ having two solid-state imaging elements provided thereon is provided in the rear of a driver's seat to shoot an image of children seated in a back seat, and the same flexible imaging device 1″ is installed for shooting an image of the driver's seat.

In the flexible imaging devices 1′ and 1″, the respective solid-state imaging elements are so adapted as to be capable of being oriented in different directions since they are respectively accommodated in separate packages.

Each of the solid-state imaging elements of the flexible imaging device converts into an electrical signal the field light formed into an image through each focusing lens, and outputs the shot image to each corresponding preprocessing unit, the corresponding DSP effects image processing, and the MPU effects integral processing the shot images obtained by the respective solid-state imaging elements.

For example, since the video picture of the two solid-state imaging elements 2a and 2b facing the front side serves as that of a stereo camera, when a video picture of a pedestrian or an oncoming vehicle is shot, this video picture is displayed on a monitor screen provided in the vehicle compartment. A distance to the object can then be determined from a distance between the solid-state imaging elements 2a and 2b and from the respective shot images as in the manner described in, for example, JP-A-2006-318062, and can be notified to the driver.

Similarly, also from the video picture of the two solid-state imaging elements 3c and 2d facing one side, a video picture of, for example, a pedestrian or the like advancing from a by-road which cannot be seen from the driver's seat can be displayed on a monitor screen, and the distance can be notified. Preferably, the MPU 8 is adapted to output an alarm upon detecting that an object to be alarmed, such as a pedestrian, has approached to within a threshold distance.

To calculate the distance to the object with high accuracy, the simultaneity of the two shot images is required, but since the simultaneity of the two shot images is ensured in this embodiment, the calculation of the distance with high accuracy becomes possible.

In addition, when the images shot by the four solid-state imaging elements are synthesized and displayed on the monitor screen, the simultaneity of the four shot images is ensured, so that the driver is able to simultaneously view an image of the lateral side at exactly the same instant as that of an image of the front side, thereby making it possible to improve the safety of driving.

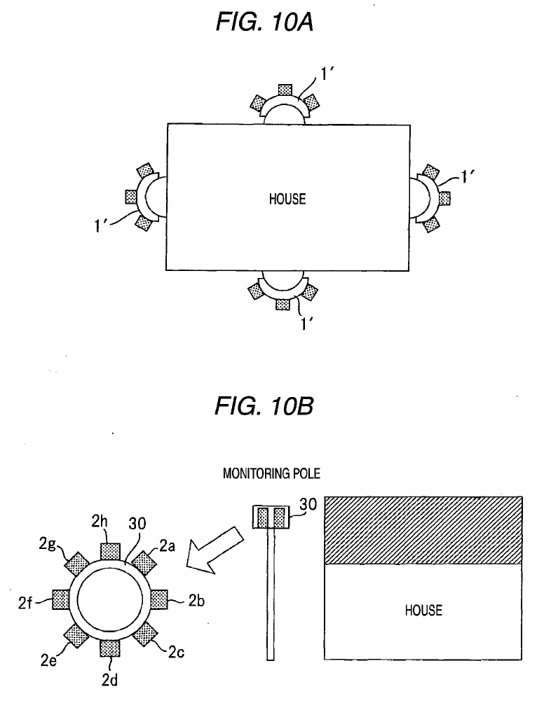

FIGS. 10A and 10B are explanatory diagrams in cases where the flexible imaging devices are installed in a house as monitoring cameras. In FIG. 10A, the flexible imaging devices 11 each having three imaging elements mounted thereon are respectively installed at a front, a right side portion, a left side portion, and a rear portion of a house by being curved, to ensure that the surroundings of the house can be monitored through 360°.

In a case where fully covering video pictures of the front side of a house are to be shot by lenses each having one solid-state imaging element, super wide angle lenses are required, and four super wide angle lenses would be required in the illustrated example, so that the installation cost of the monitoring cameras becomes high. With the flexible imaging device 1 in accordance with this embodiment, however, a fully covering video picture of the front side can be shot by mounting three solid-state imaging elements on a curved portion at tilted angles to each other in one flexible imaging device without using super wide angle lenses. Hence, by installing a total of four flexible imaging devices, the 360° monitoring of the surroundings of a house becomes possible.

In FIG. 10B, a monitoring pole is provided in front of a house, and one imaging device 30, in which eight solid-state imaging elements 2a to 2h are mounted on a flexible substrate set in a circularly rounded state, is installed on this Monitoring pole. In this imaging device 30, by pasting together the respective shot images of the eight solid-state imaging elements 2a to 2h, it is possible to synthesize a 360° monitoring video picture.

The synthesis processing of this 360° monitoring video picture is more facilitated than that in the case of the monitoring camera shown in FIG. 10A. The reason is that four imaging devices 1 are used (the timing generator is used in each imaging device) in FIG. 10A, whereas one imaging device 30 is used in FIG. 10B. Namely, the reason is that the eight solid-state imaging elements 2a to 2h are driven by output signals from one timing generator.

In the synthesis processing of the 360° monitoring video picture, since the simultaneity of the eight shot images is ensured, the integration processing of shot images which is executed by the MPU, i.e., such as retrieval processing of superimposed portions of images shot by adjacent solid-state imaging elements, is facilitated.

In addition, although the eight shot images are respectively fetched into the imaging device as moving pictures, since the acquisition timings of the respective moving pictures are completely identical among the eight solid-state imaging elements, when a video picture being captured by the solid-state imaging element 2a enters the shooting range of the adjacent solid-state imaging element 2b, the moving pictures can be recognized as an utterly identical moving picture. Hence, it is possible to obtain moving images which does not impart a sense of discomfort.

It should be noted that although in the embodiment shown in FIG. 1 a description has been given of the example in which all the four solid-state imaging elements 2a, 2b, 2c, and 2d have the infrared cut filters 3a to 3d for visible light imaging provided in front of their light receiving surfaces, it is also possible to mount filters having mutually different transmission characteristics. If visible light cut filters are used, it is possible to shoot infrared images, and if polarizing filters are used, it is possible to obtain images in which the headlights of an oncoming vehicle reflected on the road are cut off.

If shooting ranges of a plurality of solid-state imaging elements using filters having different transmission characteristics are set to an identical range, and the respective shot images are integratedly processed and are displayed on a monitor, for example, when the light has become dim and a pedestrian in the advancing direction is difficult to see, a thermal image of the pedestrian shown in the infrared image can be displayed by being superimposed on the visible light image. Even in such a case, in the imaging device 1 in accordance with this embodiment, the plurality of solid-state imaging elements operate utterly identically, and output timings of detection signals of the respective pixels from the solid-state imaging elements, A/D conversion processing timings, and timings of storage into the frame memory within the MPU 8 are identical, so that the integration processing of the respective shot images can be effected in a short time and with ease.

It should be noted that although in the embodiment described with reference to FIG. 2 the four solid-state imaging elements are arranged one-dimensionally in a horizontal row, they may be arranged two-dimensionally in 2×2 form. In addition, it goes without saying that the number of the solid-state imaging elements used is not limited to four.

In addition, although in the above-described embodiment laminated ceramic packages are used, the invention is not limited to the same, and plastic packages, for example, may be used. Still alternatively, it is also possible to further miniaturize the imaging device by using chip size packages such as those described in Japanese Patent No. 3827310.

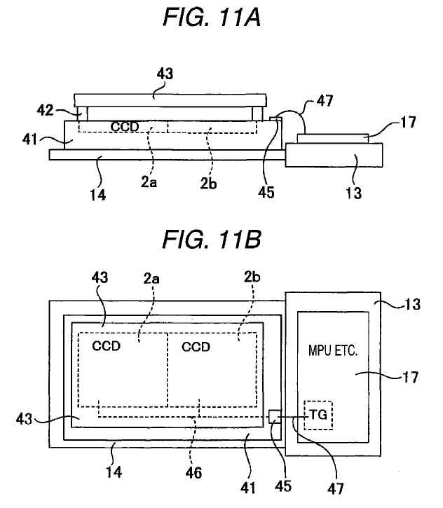

FIGS. 11A and 11B are explanatory diagrams of a chip size package. FIG. 11A is a schematic cross-sectional view of an imaging device using a chip size package. This imaging device is configured such that a spacer 42 is formed in a frame portion surrounding the solid-state imaging elements 2a and 2b on an obverse surface portion of a semiconductor substrate 41 where the imaging elements 2a and 2b are formed, and a transparent substrate such as a glass lid 43 is adhered to this spacer 42 by means of an adhesive or the like.

The semiconductor substrate 41, the transparent substrate 43, and the like are made thin so as to be provided with flexibility in themselves, and are adhered to the flexible substrate 14, as shown in FIG. 11B. In addition, the electronic circuitry 17 is mounted on the substrate 13 for electronic circuitry such as a printed circuit board, and the flexible substrate 14 is connected to the substrate 13.

Connection pads 45 are provided at an end portion of the semiconductor substrate 41, and these pads 45 and the respective imaging elements 2a and 2b are connected by a common wiring 46 formed on the semiconductor substrate. In addition, the pads 46 and the timing generator (TG) 10 of the electronic circuitry 17 are connected by a wiring 47.

There are cases where the flexible substrate 14 is used by being bent by about 90 degrees. In this case, as shown in FIG. 5, it suffices the imaging element which has been chip-size packaged is provided by being separated into a plurality of parts.

Further, although in the above-described embodiment one lens is used for each individual solid-state imaging element as shown in FIGS. 6 and 7, it is also possible to provide a configuration in which a common taking lens is used for a plurality of solid-state imaging elements.

Furthermore, although in the above-described embodiment a description has been given of the case in which the solid-state imaging elements are of the CCD type, the above-described embodiment is also applicable to a plurality of CMOS type solid-state imaging elements which are driven by one timing generator.

According to the invention, since the shooting directions of the plurality of imaging elements can be set to arbitrary directions, it is possible to reduce the number of imaging devices required. In addition, since one timing generator is used for driving the respective imaging elements, it is possible to ensure the simultaneity of images shot by the respective imaging elements, so that integration processing of the shot images is facilitated.

Since the flexible imaging device in accordance with the invention makes it possible to set shooting directions of the plurality of solid-state imaging elements to arbitrary directions, it easily becomes possible to obtain video pictures in which the shooting directions are 90 degrees different. Therefore, the flexible imaging device in accordance with the invention is useful in application to a vehicle-mounted camera, a monitoring camera, and the like.

The entire disclosure of each and every foreign patent application from which the benefit of foreign priority has been claimed in the present application is incorporated herein by reference, as if fully set forth.

What is claimed is:

1. A flexible imaging device comprising:
a flexible substrate; and
a plurality of imaging elements mounted on the flexible substrate.

2. The flexible imaging device according to claim 1,
wherein said plurality of imaging elements are at least three imaging elements, and
at least two of said at least three imaging elements are accommodated in one common package.

3. The flexible imaging device according to claim 2,
wherein the at least two imaging elements accommodated in the one common package are imaging elements which are formed adjacently on an identical semiconductor wafer and are diced out as an integral piece.

4. The flexible imaging device according to claim 2,
wherein the package is a laminated ceramic package.

5. The flexible imaging device according to claim 2, further comprising:
a lens array fitted to the package; and
imaging lenses respectively provided for said plurality of imaging elements inside the package.

6. The flexible imaging device according to claim 1, further comprising:
a timing generator that imparts an identical drive signal to each of said plurality of imaging elements.

7. The flexible imaging device according to claim 6, further comprising a first substrate on which (i) the timing generator, (ii) preprocessing sections, provided in correspondence with the imaging elements respectively, each of which preprocesses an output signal from corresponding one of the imaging elements, (iii) digital signal processing sections, provided in correspondence with the imaging elements, each of which image processes an output signal from corresponding one of the preprocessing sections, and (iv) arithmetic processing sections that integratedly processes output image data from the digital signal processing sections are mounted,
wherein the first substrate is provided continuously to the flexible substrate.

8. The flexible imaging device according to claim 6, which has a connection configuration such that said plurality of imaging elements and the timing generator are connected by a common wiring,
wherein an identical drive signal is branched from the common wiring to each of the imaging elements.

9. The flexible imaging device according to claim 1,
wherein said plurality of imaging elements comprise filters having different transmission characteristics, the filters being provided in front of light receiving surfaces of the imaging elements respectively.

10. The flexible imaging device according to claim 1,
wherein the imaging elements are of a CCD type.

11. The flexible imaging device according to claim 7,
wherein the arithmetic processing section comprises a section that, when two of the imaging elements are shooting an identical object, calculates a distance to the object from a distance between the two imaging elements and images shot by the imaging elements.

12. The flexible imaging device according to claim 11,
wherein the arithmetic processing section comprises a section that outputs an alarm upon detecting that the calculated distance to the object has reached a threshold distance or less.

13. The flexible imaging device according to claim 1, which is a vehicle-mounted camera.

14. The flexible imaging device according to claim 1, which is a monitoring camera.
